(19) United States
(12) Patent Application Publication
(10) Pub. No.: US 2010/0057590 A1
(43) Pub. Date: Mar. 4, 2010

(54) System and Method for Data Acquisition and Processing

(76) Inventor: Philip Wesby, Stratford-upon-Avon (GB)

Correspondence Address: Sunstein Kann Murphy & Timbers LLP, 125 SUMMER STREET, BOSTON, MA, 02110-1618, US

(21) Appl. No.: 12/531,149

(22) PCT Filed: Mar. 12, 2008
(86) PCT No.: PCT/GB08/00848

§ 371 Date: Sep. 14, 2009

(30) Foreign Application Priority Data
Mar. 13, 2007 (GB) 0704856.4

(51) Int. Cl. G06Q 30/00; G06F 17/00; G06F 17/30; G06Q 40/00; G06F 7/04

(52) U.S. Cl. 705/27; 700/94; 707/769; 705/43; 704/275; 340/5.84; 705/44; 707/783; 707/E17.108; 707/E17.101

(57) ABSTRACT

A system and method for data acquisition and processing is described which can audio data form the basis of new and improved business and consumer services. Audio datagrams such as short duration audio-recordings made from radio or television broadcasts or from a CD player or an MP3 player or the like are captured using a microphone associated with a multimedia computer or mobile phone or PDA or fixed line device and processed to create a digital audiogram dataset which may be subsequently transmitted to a data processing server which comprises a music and or audio archive. A server receives and processes the digital audiogram dataset to enhance the captured audio data and convert it into a suitable format which matches the format of the audio data stored in the server archive. A search engine processes the received digital audiogram and attempts to match the captured audio data with data stored in the archive. When a successful match is made between the audio datagram such as with a genuine piece of music by a recognised artist, a message is sent back to the device which initiated the audio capture and transmission process, or to an email address registered to the device, indicating the name of the artist and the name of the song and details where the music or recorded broadcast can be obtained. The audio datagram capture-and-search process may form part of a service profile for a mobile subscriber and it may be directly linked with a mobile payment transaction service so that the subscriber may order and buy a copy of the music or broadcast directly.

### BACKGROUND OF THE INVENTION

The current invention relates to a system and method for data acquisition and processing.

In particular, the invention relates to a system and method for capturing and or processing a stored or received short duration audio recording or audio datagram such from broadcasts by radio or television or from music being played via a CD player or an MP3 player or an MP4 player for the purpose of determining information about the broadcast such as the artist, the name of the music and the like.

More particularly, the invention relates to a system and method for capturing and or processing stored or received short duration audio recordings or audio datagrams such as from radio or television broadcasts or being played via a CD player or an MP3 player or an MP4 player and the like wherein the short duration audio recordings or audio datagrams are captured using a microphone associated with a mobile phone or PDA or fixed line device and processed to create a digital audiogram dataset which may be subsequently transmitted to a data processing server which is directly linked to a music and or audio archive. The dataset is received by the server and the digital audiogram is processed to enhance the captured audio data and converted into a suitable format which matches the format of the audio data stored in the server archive. A search engine processes the received digital audiogram and attempts to match the captured audio data with data stored in the archive. When a successful match is made between the audio datagram such as with a genuine piece of music by a recognised artist, a message is sent back to the device which initiated the audio capture and transmission process, or to an email address registered to the device, indicating the name of the artist and the name of the song and details where the music or recorded broadcast can be obtained. The audio datagram capture-and-search process may form part of a service profile for a mobile subscriber and it may be directly linked with a mobile payment transaction service so that the subscriber may order and buy a copy of the music or broadcast directly.

This patent application extends the invention of an earlier patent application United Kingdom Patent Application 0619761.0 by the same applicant entitled System and Method for Data Acquisition and Processing having priority date Oct. 6, 2006. In this patent application is taught the method of using datagrams and combining these with user profiles stored within the data capture device, such as a mobile phone or PDA, to create a range of differentiated services.

The current invention can be considered as key inventive extensions of this technology towards the provision of new and exciting and efficient services which are based upon capturing a short duration of audible data which forms part of broadcast programmes or broadcast music using a device with a microphone such as a mobile phone or PDA or multimedia computer or fixed line device.

Today, mobile network operators and mobile phone and multimedia computer manufacturers are seeking business solutions and technologies which exploit the untapped potential of the mobile phone or PDA or wireless laptop in order to render it as the intelligent device for desirable consumer and business oriented transaction services. The processing capability of the mobile phone is greatly increasing and the term ‘multimedia computer’ is more frequently being used to describe it.

Nevertheless, many challenges are facing the mobile network operators as consumers seek data-rich and focussed information services and progressively view the mobile operators as managed high-capacity bit pipes offering multi-bearer (GSM, GPRS, 3G, WLAN, WIMAX et al) access networks. Even the search engine companies themselves are offering relatively few solutions which can be offered by way of the mobile phone to reduce churn and increase subscriber loyalty. Current initiatives merely involve directing adverts to Internet web surfers based upon their history of surfing. A business model based upon generally random wanderings through the internet faces many challenges.

The mobile phone comprises several key technical components which are not successfully exploited to their full. The microphone and auditory capture processing capability of wireless devices is of high capability and it offers itself for other services. Analogue sound can be captured over a wide frequency range and digitalised to form a highly accurate dataset of audio data. This can offer the basis of a music search engine service and other similar services whenever a person wishes to know the name of a piece of music or other information about a broadcast transmission.

Often persons hear tracks of music, such as orchestral works or popular music from artists, which they find immediately pleasurable. It is often difficult to determine who the artist is or the name of the music which is being played or who is playing it so that a copy of the music can be purchased.

If it were possible to create a solution which enabled a person to capture a short duration of an audio broadcast and process it into an audio dataset which could be sent to a remote server in addition to data indicating the source of the request and or details of the requester such as an email address and the like, and wherein the audio dataset is identified, then the person could receive information to identify and or to purchase the music.

Further to the limitations of existing methods used for identifying audio broadcasts and the creation of new and exciting consumer services, and so far as is known, no optimum system and method for data acquisition and processing is presently available which is directed towards the specific needs of this problem area as outlined.

### OBJECTS OF THE INVENTION

Accordingly, it is an object of the present invention to provide an improved system and method for data acquisition and processing which serves to use a wireless or fixed line device which comprises a microphone to capture and or process audio broadcast transmissions and generate a data set which can then be used to gain access to one or more services.

It is a further object of one embodiment of the present invention to provide a system and method for data acquisition and processing which makes use of a wireless or fixed line device which comprises a microphone to capture and or process short duration audio recordings being part of a complete audio broadcast such as from radio or television or from music being played by a digital music player wherein a dataset is compiled from the captured audio data and transmitted to a remote server to be processed.

It is a further object of one embodiment of the present invention to provide a system and method for data acquisition and processing which makes use of a wireless or fixed line device which comprises a microphone to capture and or process short duration audio recordings being part of a complete audio broadcast such as from radio or television or from music being played by a digital music player wherein a dataset is compiled from the captured audio data and transmitted to a remote server to be processed wherein the remote server receives and processes the dataset and compares it with an archive of data to determine the identity of the dataset and the identity of the broadcast.

It is a further object of one embodiment of the present invention to provide a system and method for data acquisition and processing in which audio transmissions are captured and processed and sent to a remote server to determine the identity of the broadcast to which the captured audio data forms a part wherein the identity is then transmitted back to the device which initiated the identity request and or to an email address pre-registered and associated with the identity of the device which initiated the identity request.

It is a further object of one embodiment of the present invention to provide a system and method for data acquisition and processing in which audio transmissions are captured and processed and sent to a remote server which comprises an audio archive and a data-searching capability in which audio datasets are each processed to match each dataset with a part of an archived audio file such as a piece of recorded music and thereby identify the audio dataset.

It is a further object of one embodiment of the present invention to provide a system and method for data acquisition and processing in which audio transmissions are captured and processed and sent to a remote server which comprises an audio archive and wherein the server and associated searching processes has the capability to convert the dataset into an appropriate data format and or to correlate the audio dataset with the data stored in the audio archive.

It is a further object of one embodiment of the present invention to provide a system and method for data acquisition and processing in which audio transmissions are captured and compiled into an audio dataset which is transmitted to an audio data-processing server which receives and processes the audio dataset and request identity data such as the device identity and any related subscriber data and the like, wherein the server creates a digital audio signature which may be used to identify the audio dataset as part of a recording stored in the archive.

It is a further object of one embodiment of the present invention to provide a system and method for data acquisition and processing which can form the basis of a music capture and search process so that the identity of a particular piece of music can be determined wherein the device used to initiate the search request is then linked to a payment transaction service such as via a web page displayed on the capturing device to enable the purchase of the identified music.

It is a further object of one embodiment of the present invention to provide a system and method for data acquisition and processing which can form the basis of a music capture and search process which makes use of a music archive which is formed by storing audio data in digital format.

It is a further object of one embodiment of the present invention to provide a system and method for data acquisition and processing which can form the basis of a music capture and search process which makes use of an audio data archive comprising a plurality of audio files ΣF wherein each audio file F in the archive is pre-processed into a set of files nF_{N} where N refers to the unique identity of the dataset and where n refers to the identity of each part audio file within each audio file F_{N} where each F(N)=ΣnF_{N} and where each unique reduced dataset nF_{N} comprises a subset of audio data such as separate data files formed from specific durations of the original recording which may be further processed such that the correlation of the received dataset with the stored format of data in F_{N} is more quickly determined.

It is a further object of one embodiment of the present invention to provide a system and method for data acquisition and processing which can form the basis of a music capture and search process performed by a data processing server wherein audio data files are stored in a precise format compatible with an optimised search engine function such that each audio file may comprise a plurality of data files wherein each data file is reduced to a single data identity which is unique within the archive by a processing function f(x) and wherein the received dataset of captured audio data is appropriately formatted into the format of stored data and processed according to the same function f(x) so that a direct 1:1 comparison may be made between the captured dataset and the data stored in the archive.

It is a further object of one embodiment of the present invention to provide a system and method for data acquisition and processing which can form the basis of a music capture and search process performed by a data processing server wherein a plurality of audio data files are stored in a precise format compatible with an optimised search engine function such that each audio file of unique identity N and of duration Tₜₒₜₐₗ may comprise a plurality of n data files where Tₜₒₜₐₗ(N)=ΣnF_{N} wherein each nF_{N} is processed from a part audio dataset of the audio file of duration Tₚₐᵣₜ seconds and stored where each part audio dataset corresponds to a duration starting t seconds after the previous part audio dataset such that Tₚₐᵣₜ is greater than t so that any captured audio data which corresponds to a duration greater than Tₚₐᵣₜ and following processing into the appropriate format will comprise at least one processed part recording stored in the archive.

It is a further object of one embodiment of the present invention to provide a system and method for data acquisition and processing which can form the basis of an audio capture and search process performed by a data processing server wherein audio data files are stored in a precise format such that each audio file may comprise a plurality of data files wherein each data file may be reduced to a compressed or single data identity, which is unique within the archive, by way of a processing function f(x) wherein the capturing device such as the mobile phone or multimedia computer or PDA comprises the capability to process the captured audio data using the same processing function f(x) such that the pre-processed dataset may be more efficiently processed when received by the data processing server.

It is a further object of one embodiment of the present invention to provide a system and method for data acquisition and processing which can form the basis of an audio capture and search process performed by a data processing server wherein an audio dataset comprising both audio data in an appropriate format as well as data which identifies the sender of the dataset is received by the server and the server determines that the sender has right of access to use the service before the captured data is processed and the identity of the broadcast of which the dataset forms part is determined.

It is a further object of one embodiment of the present invention to provide a system and method for data acquisition and processing which can form the basis of a remote person authentication system and part of a remote payment transaction service using a device such as a mobile phone or multimedia computer or PDA or fixed line device comprising a microphone wherein a voice recognition system is employed in conjunction with stored key words spoken by an individual such that a payment transaction can be further authenticated by processing words spoken by the person making the purchase.

It is a further object of one embodiment of the present invention to provide a system and method for data acquisition and processing which can form the basis of a person authentication system and form part of and increase the security of a bank cash dispenser or ATM machine as part of the cash withdrawal process wherein the ATM machine comprises a microphone into which a person is asked to speak specific words or answer specific questions and the captured audio data is processed and transmitted to a remote audio archive of the same person's spoken words wherein the ATM payment withdrawal process is dependent upon receiving data from the said archive indicative of a successful match of the spoken words and audio data stored in the archive.

It is a further object of one embodiment of the present invention to provide a system and method for data acquisition and processing which can form the basis of a remote person authentication system which may be used to gain access to a building, or access to a car park or the activation of equipment by an authenticated employee wherein a microphone and in some cases a loud speaker is situated adjacent to the door or car park barrier or equipment respectively and the captured spoken words are sent to an audio processing server and the unlocking system of the door or car park barrier or equipment is activated by a positive response from the audio processing server.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for data acquisition and processing which can form the basis of new and exciting business and consumer services which involve the use of the mobile phone or multimedia computer or PDA or fixed line device comprising a microphone as an audio data capture device wherein audio data is processed into a dataset and transmitted to a remote data processing server where it is compared with data stored in an audio archive for determining the identity of the captured data.

In essence the invention proposes some ways to create new and exciting consumer services which can improve the quality of life such as by helping to identify a particular audio track such as a piece of music transmitted during a television or radio broadcast so that a consumer can more readily identify it and purchase it. In addition the invention provides an additional layer of security around processes such as cash withdrawal from an ATM by providing the means to better authenticate an individual by capturing voice information and processing this with audio data stored at a server.

Other objects and features of the present invention will become apparent from the following detailed description considered in connection with the accompanying drawings, which disclose several key embodiments of the invention. It is to be understood, however, that the drawings are designed for the purpose of illustration only and that the particular applications are given by way of example only and do not limit the scope of the invention.

### BRIEF DESCRIPTION OF THE DRAWINGS

FIG. 1 illustrates a schematic showing how audio data is captured and processed according to one embodiment of the invention.

FIG. 2 illustrates the sequence of actions performed on the captured audio data and how it may be processed by the audio archive.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

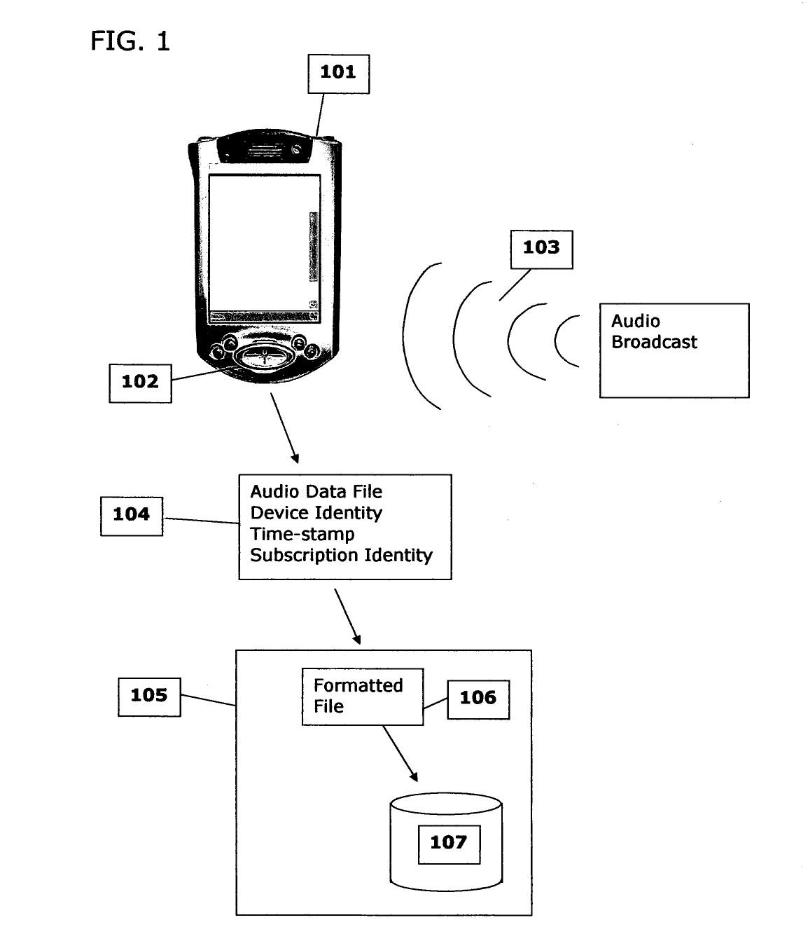

Referring now in detail to the drawings and in particular FIG. 1 thereof, therein illustrated is a schematic of one example showing how audio data is captured and processed according to one embodiment of the invention.

A wireless device such as a mobile phone or multimedia computer (101), or any suitable wireless or fixed network-linked device comprising a microphone (102) and audio data capture and storage and processing capability, captures part of an audio broadcast (103) such as a music broadcast. The broadcast audio data is recorded and stored by the device (101) and then compiled into a digital audio file (104) which is suitable for transmission and then transmitted over a fixed or wireless network and received by a digital audio data processing centre (105). The digital audio file (104) may also comprise data relating to the identity of the device, and or the time of the recording, and or the identity of the subscription holder of the audio data search service to facilitate sending the results of the audio data search process back to the person or device which initiated the audio data service request.

The received digital audio file (104) is then processed to generate a formatted data file (106) which is compatible with the format of the stored audio data digital archive (107) which forms part of the audio data processing centre (105). Upon receipt of the audio file (104), the identity data relating to the initiator of the audio search service are stored.

The formatted data file (106) is then processed into one or more search data files and then directly compared with data files stored in the audio data digital archive (107). In this way, if the audio data is stored within the archive (107) then the identity of the broadcast may be determined and transmitted back to the initiating device. In addition, the audio data search service may provide a direct link to a music purchase website and thus enable the consumer initiating the request, to not only learn the identity of the music broadcast but also to receive the direct means to purchase the identified music.

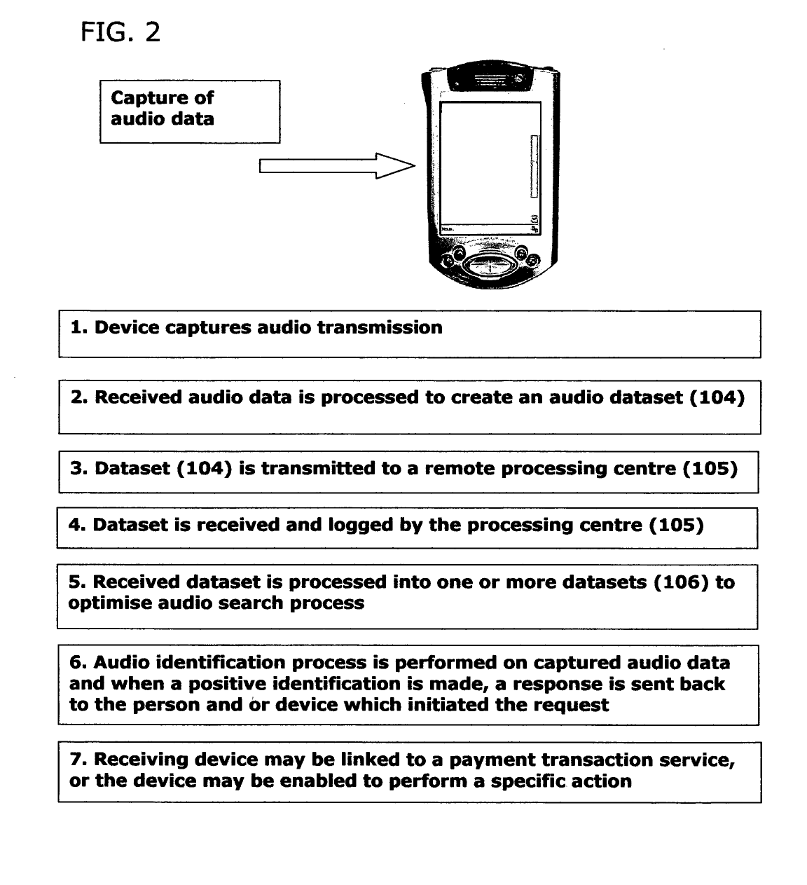

Now with reference to FIG. 2 is shown a sequence of actions which describes how the audio data processing centre (105) performs the identification process upon a received audio dataset (104).

The audio data capture and search and identification process is performed in the following sequence of actions:
1. Device captures audio transmission
2. Received audio data is processed to create an audio dataset (104)
3. Dataset (104) is transmitted to a remote processing centre (105)
4. The audio dataset (104) is received and logged by the processing centre (105)
5. The received audio data (104) may be further processed into a number of datasets (106) to match the audio data stored in the audio archive (107) and or to facilitate an optimum search process
6. When a positive identification is made of the captured audio data, the identification is sent back to the person and or device which initiated the request.
7. Depending upon the application, the receiving device may be linked to a payment transaction service to purchase the broadcast, or the receiving device becomes enabled to perform an action such as open a door, activate a car park barrier or authenticate a cash withdrawal transaction.

In one embodiment the audio data digital archive (107) comprises a plurality of audio files ΣF wherein each audio file F in the archive is pre-processed into a set of files nF_{N} where N refers to the unique identity of the dataset and where n refers to the identity of each part audio file within each audio file F_{N}. Thus each nF_{N} comprises a separate data file relating to a specific duration of the original total recording F_{N} which may be further processed such that the correlation of the received dataset (104) with the stored format of data in a particular nF_{N} is more quickly determined. It is anticipated that an optimised search engine function may be utilised such that each audio file stored in the archive may comprise a plurality of data files wherein each data file may be reduced to a limited or single data identity which is unique within the archive by a processing function f(x) and wherein a received dataset of captured audio data (104) is appropriately formatted into the format of the stored data (106) and processed according to the same function f(x) so that a direct 1:1 comparison may be made between the captured dataset (104) and the data stored in the archive (107). In one embodiment, the capturing device such as the mobile phone or multimedia computer may comprise the capability to process the captured audio data using the same processing function f(x) such that the dataset may be more efficiently processed by the data processing server.

To perform the audio data search identification service, the received and processed data file (106) will be searched within the archive. Each archived audio file F of identity N and of duration Tₜₒₜₐₗ may comprise a plurality n of data files where Tₜₒₜₐₗ(N)=ΣnF_{N} wherein each nF_{N} is processed from a part audio dataset of duration Tₚₐᵣₜ seconds of the total audio file and stored, wherein each part audio dataset starts t seconds after the previous recording such that Tₚₐᵣₜ is much greater than t so that any captured audio data which corresponds to a duration greater than Tₚₐᵣₜ and following processing into the appropriate format will comprise at least one processed part audio dataset stored in the archive.

In one embodiment, the separate audio data files nF_{N} correspond to audio data of equal duration and where entry (n) is adjacent to entry (n+1) wherein each audio data file may only differ from the next adjacent file in audio data by a small amount such as a multiple of 10 milliseconds. This approach makes possible the processing of the received data (104) into a set of search files compatible with the stored audio data archive in a more efficient way.

In an alternative embodiment, the received audio data file (104) is processed against each stored archive dataset F using a correlation method to determine a match between the processed audio file (106) and part of F wherein the received file (104) of duration t is cross correlated with each duration t within the total recording T of F in steps of s where s is much less than t which is much less than T. One can envisage the received audio data file (104) being moved along the digital file of F in steps of s and where the correlation of the file (104) is made between a part of the file F of duration t, equal in duration to the received data (104).

There is a direct application of this audio processing method and authentication of a person attempting to make use of a remote payment transaction service or other service using a mobile phone or multimedia computer or other device comprising audio capture and processing capability. In this application, actual words spoken by the person having legitimate access to the service are processed and transmitted for comparison with words stored remotely at the archive. In the instance of linking this method to cash withdrawal from an ATM or bank cash point machine, the ATM payment withdrawal process is dependent upon receiving data from the said archive indicative of a successful match of the spoken words and audio data stored in the archive.

Other applications include voice-activated building access and or car park access.

In other instances, the invention may be applied to provide building zone access to company personnel, and often inside buildings where network coverage is very poor or unavailable due to Faraday shielding effects. Employees make use of their mobile phone as the primary device and the incorporation of the mobile phone as a local service activation device correspondingly enables data capture using the mobile phone, processing according to access rights and activation of building automated doors using a local service activation capability.

From a consumer perspective, to subscribe to this audio broadcast identification service for music identification and purchase transaction will generally require a registration which may involve the payment of an opt-in fee and submission of general identification data such as address and email etc.

In the separate application of the ATM or bank cash withdrawal service, setting up each personal account will require the bank consumer to activate the voice activated service by speaking a sequence of defined words into a secure audio archive in advance of being able to use the service.

It is anticipated that digital radio audio broadcasts and music broadcasts will evolve to comprise digital markers embedded within the broadcast and transmitted periodically such as every few seconds or at the start or end of a piece of music. It is further anticipated that these digital markers will generally be inaudible to the listener, or will be deliberately added to identify the music but render it of less quality than the purchased copy. Correspondingly, the capturing device need only capture one or more of these digital markers and transmit these to the remote audio processing centre for the audio broadcast to be identified.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

1. A system for capturing and processing stored or received short duration audio recordings or audio datagrams wherein said short duration audio recordings or audio datagrams being received from radio or television broadcasts or being played via a CD player or an MP3 player or an MP4 player characterised by:
a wireless device being a mobile phone or multimedia computer (101), or being a suitable wireless or fixed network-linked device comprising a microphone (102),
means for capturing audio data and for storing and processing said audio data, or for capturing part of an audio broadcast (103) wherein said part of an audio broadcast (103) being a music broadcast,
means for recording and storing said audio data in said wireless device (101), and
means for compiling said recorded and stored broadcast audio data into a digital audio file (104) suitable for transmission and means for transmitting said digital audio file (104) over a fixed or wireless network to a digital audio data processing centre (105).

2. A system for capturing and processing stored or received short duration audio recordings or audio datagrams according to claim 1 wherein
said digital audio file (104) further comprising data relating to the identity of said wireless device (101), and/or the time of the recording, and/or the identity of the subscription holder for initiating an audio data service request to an audio data search service for allowing said audio data search service to send the results of an audio data search process back to said subscription holder or wireless device (101).

3. A system for capturing and processing stored or received short duration audio recordings or audio datagrams according to claim 2 wherein
said audio data processing centre (105) further comprising means for receiving and means for processing said digital audio file (104) for generating a formatted data file (106) compatible with the format of a stored audio data digital archive (107), and means for storing the identity data relating to the initiator of said audio search service upon receipt of said audio file (104).

4. A system for capturing and processing stored or received short duration audio recordings or audio datagrams according to claim 3 wherein said
means for processing said formatted data file (106) processing said formatted data file (106) into one or more search data files, and
means for comparing said one or more search data files with data files stored in said audio data digital archive (107) for
determining if said audio data is stored within said audio data digital archive (107), and
determining the identity of said broadcast, and
transmitting back said identity to the initiating wireless device (101).

5. A system for capturing and processing stored or received short duration audio recordings or audio datagrams according to claim 4 wherein
said audio data search service further comprising a direct link to a music purchase website for enabling the consumer initiating said request, to purchase said identified music.

6. A system for capturing and processing stored or received short duration audio recordings or audio datagrams according to claim 4 wherein
said captured audio data being actual words spoken by the person having legitimate access to said service are processed and transmitted for comparison with words stored remotely at said stored audio data digital archive (107), for cash withdrawal from an ATM or bank cash point machine wherein said ATM payment withdrawal process being dependent upon receiving data from said stored audio data digital archive (107) indicative of a successful match of the spoken words and said audio data stored in said stored audio data digital archive (107), or
said captured audio data being processed according to access rights and activation for voice-activating building access or car park access, or for providing building zone access to company personnel or for activating building automated doors using a local service activation.

7. A system for capturing and processing stored or received short duration audio recordings or audio datagrams according to claim 1 wherein said digital radio audio broadcasts and music broadcasts further comprising digital markers embedded within said broadcast wherein said digital markers being either transmitted periodically or at the start or end of a piece of music, and
said digital markers being inaudible to the listener or being deliberately added for identifying the music and for rendering it of less quality than the purchased copy.

8. A system for capturing and processing stored or received short duration audio recordings or audio datagrams according to claim 7 further characterised by said capturing device only capturing one or more of said digital markers and transmitting only said digital markers to said digital audio data processing centre (105) for the said audio broadcast to be identified.

9. A system for capturing and processing stored or received short duration audio recordings or audio datagrams according to claim 1 wherein said digital audio data processing centre (105) comprising an audio data digital archive (107), wherein
said audio data digital archive (107) further comprising a plurality of audio files ΣF wherein each of said audio file F in said archive (107) being pre-processed into a set of files nF_{N} where N refers to the unique identity of the dataset and where n refers to the identity of each part audio file within each audio file F_{N}, and
each of said set of files nF_{N} comprising a separate data file relating to a specific duration of the original total recording F_{N}.

10. A system for capturing and processing stored or received short duration audio recordings or audio datagrams according to claim 9 wherein said set of files nF_{N} corresponding to audio data of equal duration, wherein entry (n) being adjacent to entry (n+1) wherein each audio data file only differing from the next adjacent file in audio data by a small amount.

11. A system for capturing and processing stored or received short duration audio recordings or audio datagrams according to claim 9 wherein
said received audio data file (104) being processed against each of said stored archive dataset F using a correlation method to determine a match between the processed audio file (106) and part of F wherein said received file (104) of duration t being cross correlated with each duration t within the total recording T of F in steps of s wherein s being much less than t and wherein t being much less than T.

12. A method for capturing and processing stored or received short duration audio recordings or audio datagrams wherein said short duration audio recordings or audio datagrams being received from radio or television broadcasts or being played via a CD player or an MP3 player or an MP4 player characterised by the steps of:
capturing audio data, or part of an audio broadcast (103) wherein said part of an audio broadcast (103) being a music broadcast being captured by a wireless device being a mobile phone or multimedia computer (101), or being a suitable wireless or fixed network-linked device comprising a microphone (102),
storing and processing said audio data or said part of an audio broadcast (103), recording and storing broadcast audio data in said wireless device (101).

13. A method for capturing and processing stored or received short duration audio recordings or audio datagrams according to claim 12 further comprising the steps of;
compiling said recorded and stored broadcast audio data into a digital audio file (104) suitable for transmission, and
transmitting said digital audio file (104) over a fixed or wireless network to a digital audio data processing centre (105).

14. A method for capturing and processing stored or received short duration audio recordings or audio datagrams according to claim 13 further comprising the steps of;
said digital audio file (104) further comprising data relating to the identity of said wireless device (101), and/or the time of the recording, and/or the identity of the subscription holder for initiating an audio data service request to an audio data search service.

15. A method for capturing and processing stored or received short duration audio recordings or audio datagrams according to claim 14 further comprising the steps of;
receiving by said audio data processing centre (105), and
processing said digital audio file (104) for generating a formatted data file (106) compatible with the format of the stored audio data digital archive (107), either for matching the audio data stored in the audio archive (107) or for facilitating an optimum search process, and
storing the identity data relating to the initiator of said audio search service upon receipt of said audio file (104).

16. A method for capturing and processing stored or received short duration audio recordings or audio datagrams according to claim 15 further comprising the steps of;
comparing said one or more search data files with said data files stored in said audio data digital archive (107) for
determining if said audio data is stored within said audio data digital archive (107), and when a positive identification is made of the captured audio data,
determining the identity of said broadcast, and
transmitting back said identity to the initiating person or wireless device (101) having initiated said request.

17. A method for capturing and processing stored or received short duration audio recordings or audio datagrams according to claim 16 further comprising the steps of;
initiating a request for purchasing said identified broadcast music by the consumer wherein said audio data search service further comprising a direct link to a music purchase website, and
linking said receiving wireless device (101) to a payment transaction service.

18. A method for capturing and processing stored or received short duration audio recordings or audio datagrams according to claim 16 wherein
said captured audio data being actual words spoken by the person having legitimate access to said service are processed and transmitted for comparison with words stored remotely at said stored audio data digital archive (107), for cash withdrawal from an ATM or bank cash point machine wherein said ATM payment withdrawal process being dependent upon receiving data from said stored audio data digital archive (107) indicative of a successful match of the spoken words and said audio data stored in said stored audio data digital archive (107).

19. A method for capturing and processing stored or received short duration audio recordings or audio datagrams according to claim 16 wherein
said captured audio data being processed according to access rights and activation for voice-activating building access or car park access, or for providing building zone access to company personnel or for activating building automated doors using a local service activation.

20. A system for capturing and processing stored or received short duration audio recordings or audio datagrams wherein
said captured audio data being actual words spoken by a person having legitimate access to a service are processed and transmitted for comparison with words stored remotely at a remote audio data digital archive (107), wherein the service comprises cash withdrawal from an ATM or bank cash point machine wherein said ATM payment withdrawal process being dependent upon receiving data from said stored audio data digital archive (107) indicative of a successful match of the spoken words and said audio data stored in said stored audio data digital archive (107).
